(19) United States
(12) Patent Application Publication
(10) Pub. No.: US 2014/0032722 A1
(43) Pub. Date: Jan. 30, 2014

(54) Controlling Characteristics of Network Device Widgets through a Network Device

(71) Applicant: Matthew S. Snow, San Rafael, CA (US)

(72) Inventor: Matthew S. Snow, San Rafael, CA (US)

(73) Assignee: Adobe Systems Incorporated, San Jose, CA (US)

(21) Appl. No.: 12/474,996

(22) Filed: May 29, 2009

(51) Int. Cl. G06F 15/173; G06F 15/177; G06F 3/01

(52) U.S. Cl. 709/220; 715/735; 709/223; 715/769

(57) ABSTRACT

The embodiments described herein provide various techniques to control characteristics of widgets on a network device. A widget control application is provided to a first network device. This widget control application provides a user interface having a list of available widgets and a graphical emulation of a second network device. An ordered list of widgets is received from the first network device and used to generate a configuration file. The configuration file is provided to the second network device over a communication network in order to cause the second network device to display the ordered list of widgets, thus synchronizing the ordered list between the first network device and the second network device.

### FIELD

The present disclosure relates generally to widgets, and more particularly, in an example embodiment, relates to controlling characteristics of widgets on a second network device through a first network device.

### BACKGROUND

The use of widgets is popular on the Internet. Widgets are typically displayed as part of a graphical interface which allow a user to interact with applications. Widgets may be represented as objects (e.g., icons, buttons) with which a user can interact. For example, a user may move a widget from a website to a different location, such as the user's desktop device.

### BRIEF DESCRIPTION OF DRAWINGS

Various ones of the appended drawings merely illustrate exemplary embodiments and cannot be considered as limiting its scope.

FIG. 1 is a block diagram illustrating an exemplary embodiment of a network architecture of a system used to control characteristics of network device widgets.

FIG. 2 is a block diagram illustrating an exemplary embodiment of a management server.

FIG. 3a is an exemplary interface illustrating widget control for a mobile device.

FIG. 3b is an exemplary interface illustrating widget control for an Internet television.

FIG. 4 is a flowchart illustrating an exemplary method to enable a network device to provide network device widget control.

FIG. 5 is a flowchart illustrating an exemplary method to control characteristics of widgets on a new network device.

FIG. 6 is a flowchart illustrating an exemplary method to synchronize a widget configuration.

FIG. 7 is a simplified block diagram of a machine in an exemplary form of a computing system within which a set of instructions for causing the machine to perform any one or more of the methodologies discussed herein may be executed.

### DESCRIPTION OF EXAMPLE EMBODIMENTS

The description that follows includes illustrative systems, methods, techniques, instruction sequences, and computing machine program products that embody the present invention. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on a desktop device, the embodiments are given merely for clarity in disclosure. Thus, any type of computing or network device having a display may be used and is considered as being within a scope of exemplary embodiments. Each of a variety of exemplary embodiments is discussed in detail, below.

Exemplary embodiments provide a system and method for controlling characteristics of network device widgets through a network device. A widget can be an element of a graphical user interface (GUI) or other interface type that displays information or provides a way for a user to interact with, for example, an operating system or application. The widget can be a chunk of code that can be installed and executed by an end user without requiring additional compilation. Widgets may take the form of on-screen graphics, buttons, icons (e.g., clocks, daily weather), text, or any combination thereof.

In a more specific example, the widget may be moved from a list of available widgets to a list associated with a particular network device. In one exemplary embodiment, the list associated with the particular network device is displayed within an emulation (e.g., a graphical representation) of the particular network device in a what you see is what you get (WYSIWYG) manner. The user may also order the widgets or delete unused widgets on the emulation of the particular network device. A resulting list of widgets is then synchronized to the particular network device via a network. The network may comprise a wireless network, a wired network, or a combination of both.

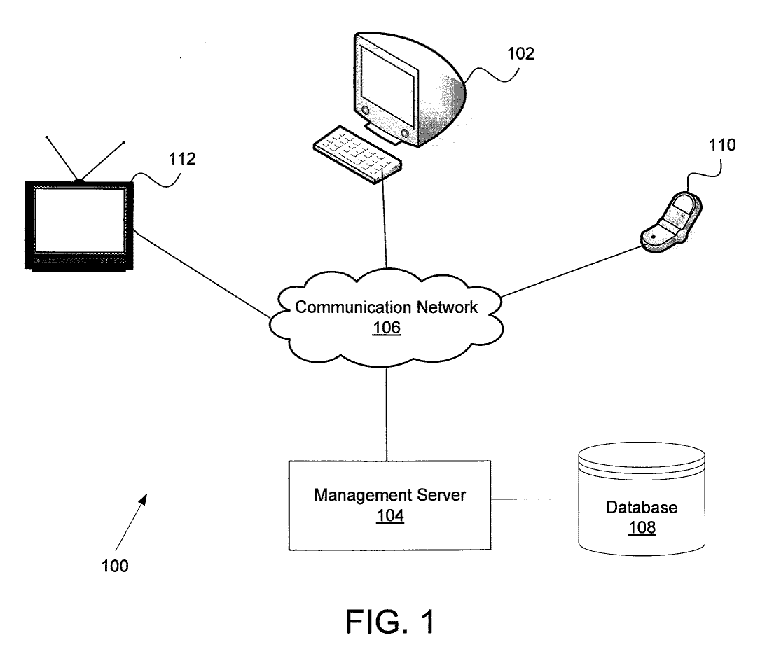

With reference to FIG. 1, an exemplary embodiment of a high-level network architecture 100 for controlling characteristics of network device widgets through a (configuring) network device 102 is shown. The network device 102 provides an interface whereby a user may manipulate widgets. In exemplary embodiments, a graphical user interface is provided on the network device 102 which provides a listing of available widgets and an emulation of a second network device associated with a user of the network device 102 on which widgets are currently being controlled. While the network device 102 is depicted as a desktop device or computer, it will be appreciated that the network device 102 may be any network or computing device (e.g., laptop) that is configured to at least receive user inputs to manipulate the widgets and configured to display the widgets and the emulation.

The network device 102 is coupled to a management server 104 via a communication network 106. The communication network 106 is a collection of interconnected processing systems that communicate utilizing wireless mediums. Examples of communication networks, such as the communication network 106, include Local Area Networks (LANs) and/or Wide-Area Networks (WANs) (e.g., the Internet).

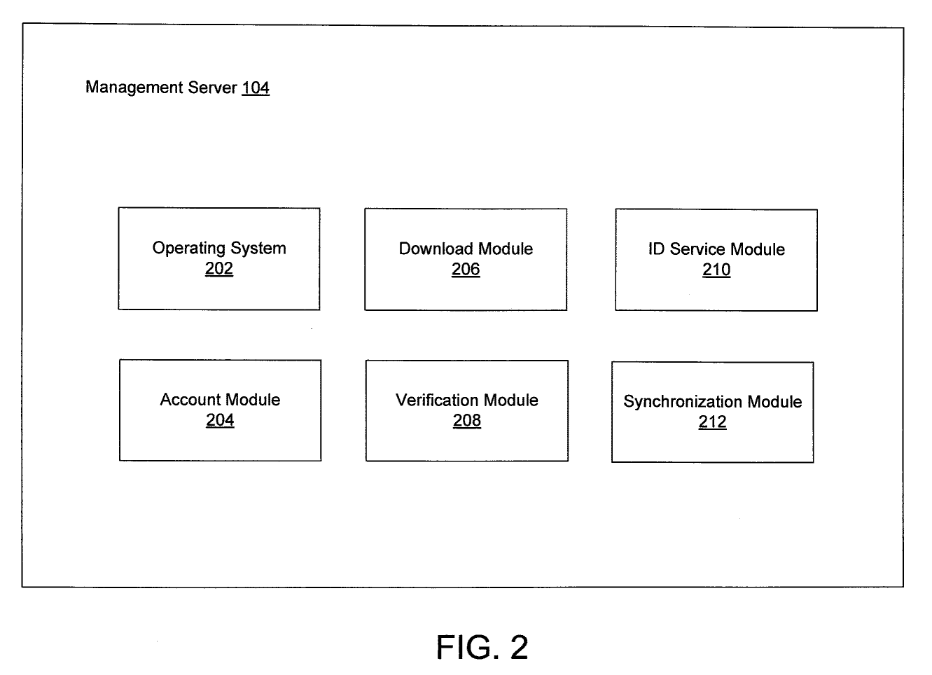

The management server 104 manages user accounts and synchronization of an ordered list of widgets to an appropriate network device. At least one database 108 is coupled to the management server 104 to store user account information. The management server 104 will be discussed in more detail in connection with FIG. 2 below.

As depicted in FIG. 1, the second network device may include a mobile phone 110 or an Internet-connected television 112. It is noted that the second network device may be any device that can receive data via the communication network 106 and can perform applications associated with widgets provided to the second network device.

FIG. 2 is a block diagram of a management server 104 according to one embodiment. The management server 104 is a processing system used to implement logic, applications, methods, or processes to control characteristics of network device widgets, as described in more detail below. The management server 104 is configured to execute an operating system 202 that manages the processes and/or services executing on the management server 104. As depicted in FIG. 2, these processes and/or services may be provided by an account module 204, a download module 206, a verification module 208, an identity (ID) service module 210, and a synchronization module 212. These modules may be implemented as hardware, software, or firmware. While a management server 104 is described, one skilled in the art will recognize that the management server 104 may be embodied as a processing system deployed in the form of a variety of computing devices, such as personal computers, laptop computers, and other computing devices.

The account module 204 is configured to allow users to establish user accounts for various services provided by the management server 104, and to maintain updates to their accounts. Updates to a user account may include addition (e.g., registration) of network devices that the user desires to utilize embodiments of the present inventive subject matter upon, deletion of network devices previously employing embodiments of the present inventive subject matter, changes in login data (e.g., user name and password), addition or deletion of services, and user preferences. The user preferences may configure some of elements associated with widgets. For example, a user's zip code may be used to determine a user's location such that location-specific widgets or data may be provided to the user's devices. User account information is stored in a database (e.g., database 108) and is accessed when needed for at least verification and synchronization purposes as will be discussed further below.

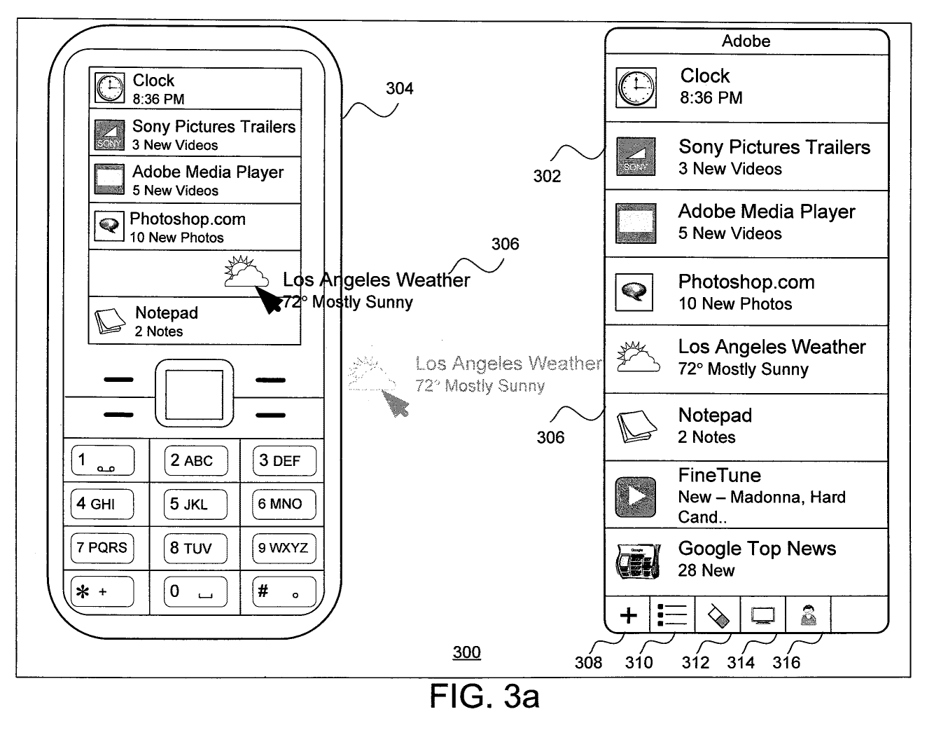

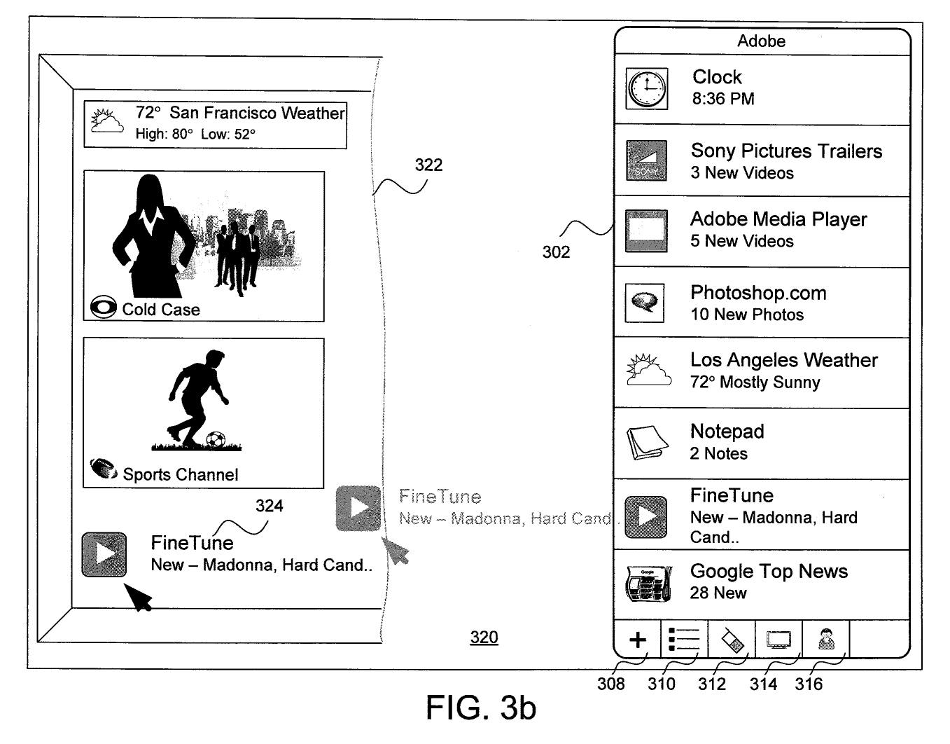

The download module 206 provides software to various devices in order for these devices to operate in such a manner as to provide one or more services associated with the management server 104. In one exemplary embodiment of the present invention, the download module 206 provides the network device (e.g., desktop device) with software that allows the network device to provide a widget control interface (e.g., control interfaces shown in FIG. 3a and 3b) and to generate widget configuration files. The download module 206 also provides software to the second network device (e.g., mobile device 110 or Internet connected television 112) during a network device registration process to allow the second network device to receive and implement widget configurations.

The verification module 208 performs verification on new network devices. In exemplary embodiments, a new network device identifier (e.g., a phone number for the mobile device 110) is received from a user at the network device. The verification module 208 uses the network device identifier to route software or instructions from the download module 206 to the second network device. The verification module 208 may also generate a verification code to insure a proper network device is associated with the user. For example, the verification code is sent to the second network device. The verification code is then entered into an interface provided on the network device that initially provided the network device identifier. This insures that the user has possession of the second network device during the registration process.

The ID service module 210 manages services provided by the management server 104. After a user logs into any device registered with the management server 104, the ID service module 210 will identify all services available to a user of the device. Furthermore, the ID service module 210 has knowledge of all network devices associated with a user account of the user and an appropriate platform associated with each network device.

The synchronization module 212 synchronizes an ordered listing of widgets from the network device with the second network device. In exemplary embodiments, the synchronization module 212 receives a configuration file including the ordered list from the network device. The ordered list may be stored into a database or cached. In some embodiments, this configuration file may be received in real-time. For example, as soon as a change is made at the network device, an update ordered list may be received from the network device. Alternatively, the configuration file may be received at predetermined intervals (e.g., every 5 minutes) or upon an event (e.g., when a user elects to send the updated ordered list).

Since the ID service module 210 has knowledge of all network devices associated with each user account, the ID service module 210 in conjunction with the synchronization module 212 can configure widgets on the network devices associated with each user account by providing the configuration in an appropriate platform to each network device. For example, the ID service module 210 and the synchronization module 212 may provide a widget configuration for a mobile phone and a widget configuration for an Internet-connected television, both of these network devices being associated with a single user and user account, and both of these network devices configured using a graphical user interface provided by a same widget control application at a configuring network device (e.g., desktop device). However, the platforms of these network devices are different. Therefore, exemplary embodiments allow the control of widget characteristics of different network devices having different platforms using a single widget control application. It is further noted that the synchronization may be provided in a WYSIWYG manner.

At an appropriate time, the ordered list is synchronized with the second network device. In one embodiment, the second network device, when activated (e.g., turned on), will automatically access the management server. New configurations (e.g., an ordered list of widgets) may then be pulled or downloaded by the second network device (e.g., via e-mail). In an alternative embodiment, the synchronization module may send the configuration to the second network device. The second network device then reconfigures its widgets when activated (e.g., turned on) or upon a user command (e.g., user triggers the configuration update).

FIG. 3a and FIG. 3b illustrates graphical user interfaces which are displayed on the configuring network device and used to control characteristics of network device widgets. FIG. 3a provides an exemplary user interface 300 configuring widgets on a mobile phone (e.g., mobile phone 110). The user interface 300 includes a widget management interface 302 and a mobile phone emulation 304. The widget management interface 302 provides a listing of widgets that are associated with the user's account. The listing of widgets may include an original list of widgets provided when the user initially signed up for the widget control service. The listing of widgets may also include widgets later purchased or obtained. For example, the user may access the CNN website having a CNN top story widget. The user may then take that widget (e.g., drag it to the user's desktop, to the widget management interface 302, or to the mobile phone emulation 304).

The mobile phone emulation 304 is a graphical representation of the mobile device associated with the account. When the user registers the mobile device with the management server 104, information on the mobile device is provided to the management server and stored in the user account. The information may include the mobile device identifier (e.g., phone number) and model. By knowing the model, the management server 104 may provide data to the network device to allow the network device to create the mobile phone emulation 304 on the network device, thus giving an accurate appearance and simulation of functionality of the mobile device being configured.

Furthermore, knowledge of the model allows the management server 104, and thus the network device to only allow manipulation and control of widgets that will operate on the mobile device being configured with widgets. For example, if the mobile device is a specific mobile device model, widgets associated with applications that will not operate on the specific mobile device model will either not be displayed or is grayed out on the widget management interface 302. Additionally, these widgets may not allow selection by a cursor or other selection mechanism of the network device.

As depicted, the mobile phone emulation 304 shows a plurality of widgets already added to the mobile device. This list of widgets may have been previously provided to the mobile device or are currently being configured for the mobile device. In the present embodiment, a weather widget 306 is being added to the mobile phone emulation 304. A user may add the weather widget 306 by selecting the weather widget 306 on the widget management interface 302, dragging the weather widget 306 (e.g., shown grayed out), and dropping the weather widget 306 onto the mobile phone emulation 304 where the user desires to position the widget.

The order of the widgets on the mobile phone emulation 304 will be the order of the same widgets on the mobile device when the widget configuration is synchronized to the mobile device. As such, a user may rearrange the widgets on the mobile phone emulation 304 to their desire (e.g., by dragging and dropping the widgets around in the mobile phone emulation 304) or delete widgets that are no longer wanted.

The widget management interface 302 also provides icons, which trigger various functions. While several icons are shown in FIGS. 3a and 3b, alternative embodiments may include more, less, or other icons than those shown.

An add icon 308 opens up an interface to a marketplace where more widgets may be added. For example, a web browser may open to a widget marketplace where the user may purchase, trade, or obtain for free more widgets. The new widgets may be added to the user account at the management server (e.g., associated with the user account) or the new widgets may be directly downloaded to the network device and later synchronized with the management server.

A preference pane icon 310 triggers a preference pane. Using the preference pane, the user can change their profile, user information, and other preferences. The changes made in the preference pane may be synchronized with account information and stored at the management server.

Selection of a phone icon 312 or a television icon 314 provides a drop down menu if more than one mobile device or Internet-connected television is registered with the account associated with the user. The user selects one of the network devices from the drop down menu and an emulation of the network device (e.g., the mobile phone emulation 304) is launched. It is noted that other network devices may be represented by other icons, or a generic icon may be used to trigger a drop down menu of all registered network devices. If only one mobile device or Internet-connected television is associated with the account (and thus the widget management interface 302), then selection of the phone icon 312 or the television icon 314 may automatically launch the emulation of the selected device.

A person icon 316 allows the user to share his widgets with others. In one embodiment, the selection of the person icon 316 may trigger an e-mail message whereby one or more widgets may be sent to another person. It should be noted that some widgets may not be shared. For example, some widgets may only be used by the user purchasing the widgets.

FIG. 3b provides an exemplary user interface 320 configuring widgets on an Internet-connected television (e.g., television 112). The user interface 320 includes the widget management interface 302 and an Internet-connected television emulation 322. As with the embodiment shown in FIG. 3a, a widget (i.e., a FineTune widget 324) is being dragged and dropped from the widget management interface 302 to the television emulation 322.

It should be noted that user interfaces are not limited to the user interfaces illustrated in FIG. 3a and FIG. 3a. Emulation of any network device may be provided on user interfaces whereby the emulation has an appearance of the actual network device on which widgets are being controlled.

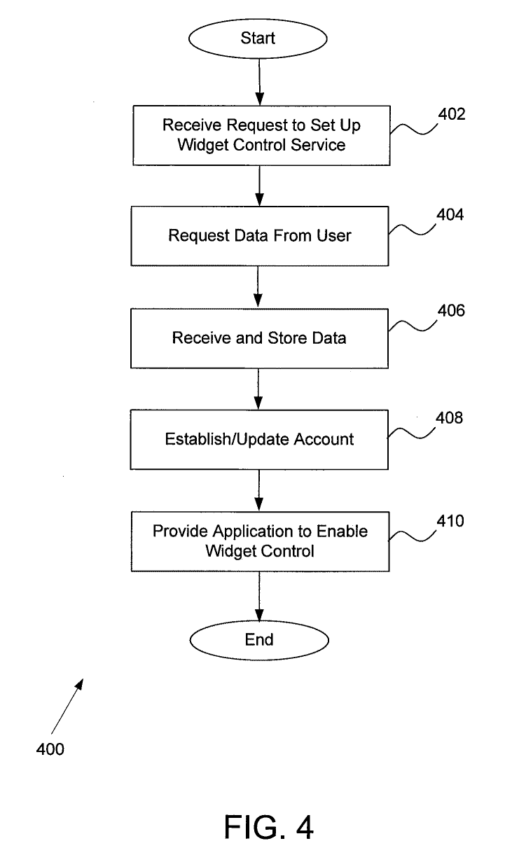

FIG. 4 is a flowchart illustrating an exemplary method 400 to enable a network device (e.g., desktop device 102) to provide network device widget control. In order for the network device to provide network device widget control, the network device registers for the widget control service with the management server. At 402, the management server receives a request to register for the widget control service. At 404, a request for data from the user is sent. The requested data may vary based on whether the user already has an account established with the management server. In some embodiments, user of the network device may already have an account established with the management server for other services. In these embodiments, the user may only need to add the widget control service to their account. This may be done, for example, by checking a widget control service box and providing approval. In some cases, payment information may also be needed.

In embodiments where the user does not have an account already established, the user will need to provide data in order to establish a new account. The data may include contact information, billing information, user name, and password. The data may further include an indication of one or more services managed by the management server to which the user would like to subscribe. As such, the user will indicate subscription to the widget control service.

The various data is received at 406 and stored. Subsequently, the account is established or updated at 408 to enable widget control service for the account.

The management server then provides an application to the network device to enable widget control at 410. In accordance with one embodiment, the download module of the management server will forward the widget control application to the network device. In exemplary embodiments, the application is an Adobe Integrated Runtime (AIR) application, which, in one embodiment, is a browser-less runtime for rich Internet applications that can be deployed onto a desktop. In the present embodiment, the AIR application may include a starter packet of widgets for use. The user may subsequently obtain more widgets (e.g., from a widget marketplace, trading widgets, or receiving widgets from friends) which are then associated with the user account.

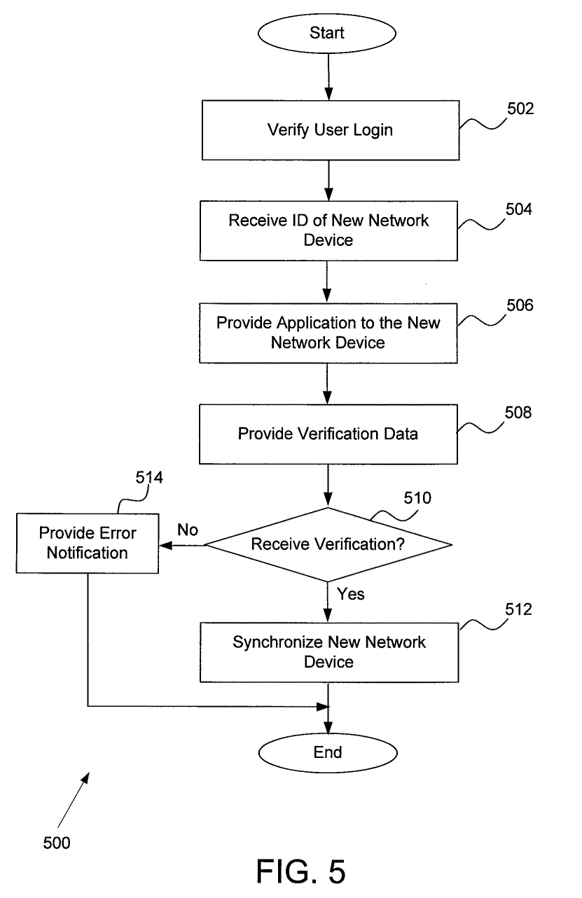

Referring now to FIG. 5, a flowchart illustrating an exemplary method 500 to control characteristics of widgets on a new network device is shown. Each new network device is registered with a management server. Thus, a user will initially log into their account with the management server. At 502, a user login is verified. The user login may include, for example, a user name and a password.

Upon verification of the user login, the user will be asked to provide an identifier for the new network device. At 504, the identifier is received by the management server. The identifier may comprise a network address associated with the new network device, a phone number associated with the new network device, or any other unique identifier that is associated with the new network device.

At 506, a widget control application is provided to the new network device. In one embodiment, a message (e.g., a SMS message) is sent by the management server to the new network device. The message may be sent using the identifier received at 504. In exemplary embodiments, the message will download and install a device widget control application on the new network device. The device widget control application will allow the new network device to receive widget configuration files from the management service, and to manage the widgets according to the widget configuration files.

At 508, verification data is provided. The verification data may be a verification code that is provided to one device and entered in a second device. For example, the verification code for a new network device may be provided to the new network device along with the widget control application. The verification code is then entered in the network device (e.g., desktop device) which provided the new network device identifier. Alternatively, the verification code is provided to the network device and entered into the new network device. This verification process ensures that the user is in possession of both the network device and the new network device.

If a correct verification code is received at 510, then the management server synchronizes the new network device with a widget configuration file, if one is available. However, if the verification code is not received or is incorrect at 510, then the new network device is not associated with the user account, will not receive any widget configuration files, and is provided an error notification at 514. The error notification may be sent, for example, to the network device after a particular amount of time has passed without receipt of a correct verification code.

The method 500 of FIG. 5 is exemplary. In an alternative embodiment, more or less operations may be provided, operations may be combined, or an order of the operations may be changed. For example, verification of the new network device (operations 508 and 510) may be performed before the widget control application is provided to the new network device (operation 506).

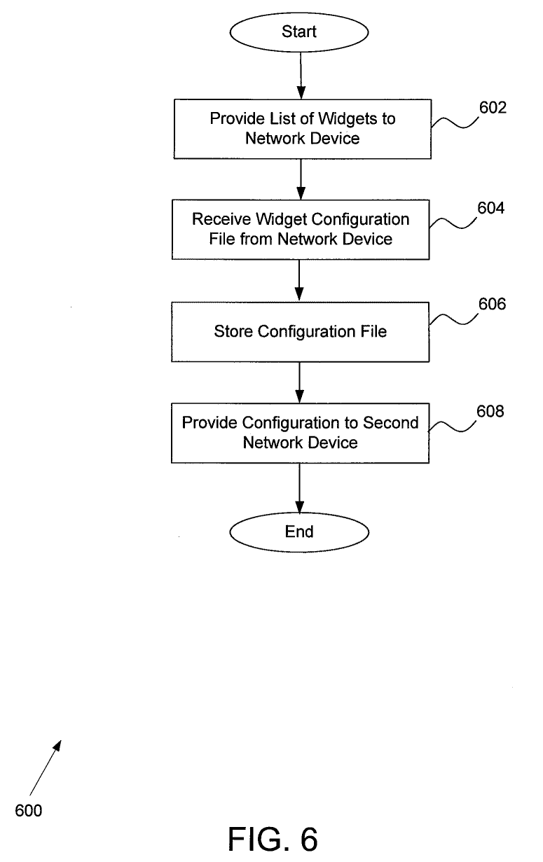

FIG. 6 is a flowchart illustrating an exemplary method 600 to synchronize a widget configuration on a network device. At 602, a list of widgets is provided to a first network device (e.g., desktop device). The list of widgets is originally provided when the first network device initially registered with the management server to receive widget control services (e.g., as a starter pack of widgets). Subsequently, new widgets may be added to the list of widgets and obsolete widgets may be removed from the list of widgets. For example, widgets may be purchases or obtained for free from a widget marketplace.

Using a user interface, such as those shown in FIG. 3a and FIG. 3b, an ordered list of widgets may be generated at the first network device. In exemplary embodiments, widgets may be dragged and dropped on a graphical emulation of the network device being configured resulting in an ordered list of widgets. A configuration file including the ordered list is sent from the first network device and received by the management server at 604. The configuration file may be received in real-time (e.g., as widgets are dragged and dropped at the first network device) or may be receive at predetermined intervals or upon an event (e.g., when a user indicates to send the widget data. The widget data also includes an identity of a second network device being configured.

Once received, the management server stores or caches the configuration file at 606 and awaits synchronization with the second network device. The configuration file provides a correct ordering of the widgets on the second network device. The configuration or ordered list is then provided to the second network device being configured at 608. In one embodiment, the configuration is pulled from the management server by the second network device. In an alternative embodiment, the configuration may be sent to the second network device. The second network device may then provide the ordered widget list on a display of the second network device.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term module may be a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

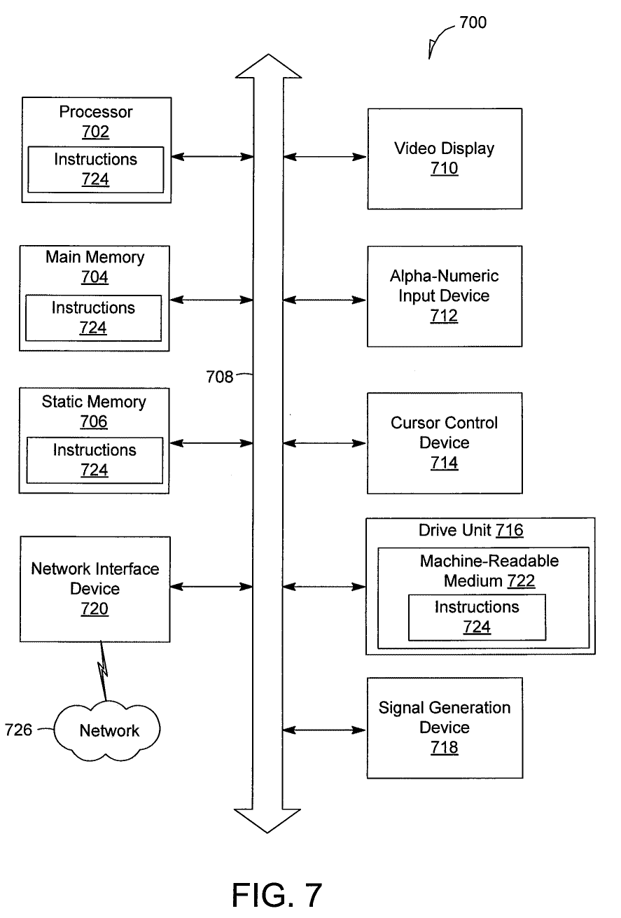

With reference to FIG. 7, an exemplary embodiment extends to a machine in the exemplary form of a computer system 700 within which instructions for causing the machine to perform any one or more of the methodologies discussed herein may be executed. In alternative exemplary embodiments, the machine operates as a standalone device or may be connected (e.g., network) to other machines. In a network deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In exemplary embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

1. A method comprising:
determining a platform of a second network device;
providing a widget control application to a first network device that provides a user interface comprising a list of available widgets, some of the widgets being compatible with the platform determined for the second network device and some of the widgets not being compatible with the platform determined for the second network device, wherein widgets not compatible with the platform determined for the second network device are displayed as non-selectable in the widget control application, the widget control application being configured to allow generation of configuration files for different network devices having different platforms including the platform determined for the second network device;
providing an icon in the user interface allowing a user to share widgets with other users, wherein selection of the icon triggers an e-mail message including a copy of a selected widget to be sent to another user;
receiving a configuration file for the second network device created using the user interface on the first network device based on the list of available widgets compatible with the platform determined for the second network device provided to the first network device, the configuration file comprising an ordered list of widgets compatible with the platform determined for the second network device and received from the first network device; and
synchronizing, using at least one processor, the ordered list of widgets with the second network device by providing the ordered list of widgets in the platform determined for the second network device to the second network device over a communication network.

2. The method of claim 1, wherein the widget control application provides a graphical emulation of the second network device and the ordered list is generated by receiving input comprising dragging and dropping widgets from the list of available widgets to the graphical emulation of the second network device.

3. The method of claim 1, wherein the widget control application provides a graphical emulation of the second network device and the ordered list is generated by receiving input rearranging widgets on the graphical emulation of the second network device.

4. The method of claim 1, wherein the widget control application provides a graphical emulation of the second network device and the ordered list is generated by receiving input deleting one or more widgets on the graphical emulation of the second network device.

5. The method of claim 1, further comprising associating new widgets with a user account of a user associated with the first network device, and providing the new widgets to the first network device.

6. The method of claim 1, further comprising receiving an identifier of the second network device, the identifier used to associated the second network device with a user account of a user associated with the first network device.

7. The method of claim 6, further comprising verifying the second network device using the identifier and a verification code.

8. The method of claim 1, further comprising receiving a second configuration file containing a second ordered list of widgets from the first network device for a third network device, and providing the second ordered list to the third network device over a communication network, the third network device having a different platform than the first network device.

9. A system comprising:
at least one processor;
a module to determine a platform of the second network device;
a processor-implemented download module to provide a widget control application to a first network device that provides a user interface having a list of available widgets, some of the widgets being compatible with the platform determined for the second network device and some of the widgets not being compatible with the platform determined for the second network device, wherein widgets not compatible with the platform determined for the second network device are displayed as non-selectable in the widget control application, the widget control application being configured to allow generation of configuration files for different network devices having different platforms including the platform determined for the second network device and to provide an icon in the user interface allowing a user to share widgets with other users, wherein selection of the icon triggers an e-mail message including a copy of a selected widget to be sent to another user; and
a processor-implemented synchronization module to receive a configuration file for a second network device, the configuration file including an ordered list of widgets received from the first network device that is created using the user interface on the first network device based on the list of available widgets compatible with the platform determined for the second network device provided to the first network device, and to synchronize, using the at least one processor, the ordered list of widgets with the second network device by providing the ordered list of widgets in the platform determined for the second network device to the second network device over a communication network.

10. The system of claim 9, wherein the widget control application provides a graphical emulation of the second network device and the ordered list is generated by receiving input dragging and dropping widgets from the list of available widgets to the graphical emulation of the second network device.

11. The system of claim 9, wherein the widget control application provides a graphical emulation of the second network device and the ordered list is generated by receiving input rearranging widgets on the graphical emulation of the second network device.

12. The system of claim 9, wherein the widget control application provides a graphical emulation of the second network device and the ordered list is generated by receiving input deleting one or more widgets on the graphical emulation of the second network device.

13. The system of claim 9, further comprising an account module to receive an identifier of the second network device, the identifier used to associate the second network device with a user account associated with the first network device.

14. The system of claim 13, further comprising a verification module to verify the second network device using the identifier and a verification code.

15. A non-transitory machine-readable storage medium in communication with at least one processor, the machine-readable storage medium storing instructions which, when executed by the at least one processor of a machine, cause the machine to perform operations comprising:
determining a platform of the second network device;
providing a widget control application to a first network device that provides a user interface having a list of available widgets, some of the widgets compatible with the platform determined for the second network device and some of the widgets not being compatible with the platform determined for the second network device, wherein widgets not compatible with the platform determined for the second network device are displayed as non-selectable in the widget control application, the widget control application being configured to allow generation of configuration files for different network devices having different platforms including the platform determined for the second network device;
providing an icon in the user interface allowing a user to share widgets with other users, wherein selection of the icon triggers an e-mail message including a copy of a selected widget to be sent to another user;
receiving a configuration file for a second network device created using the user interface on the first network device based on the list of available widgets compatible with the platform determined for the second network device provided to the first network device, the configuration file including an ordered list of widgets compatible with the platform determined for the second network device and received from the first network device; and
synchronizing, using at least one processor, the ordered list of widgets with the second network device by providing the ordered list of widgets in the platform determined for the second network device to the second network device over a communication network.

16. The non-transitory machine-readable storage medium of claim 15, wherein the widget control application provides a graphical emulation of the second network device and the ordered list is generated by receiving input dragging and dropping widgets from the list of available widgets to the graphical emulation of the second network device.

17. The non-transitory machine-readable storage medium of claim 15, wherein the widget control application provides a graphical emulation of the second network device and the ordered list is generated by receiving input rearranging widgets on the graphical emulation of the second network device.

18. The non-transitory machine-readable storage medium of claim 15, wherein the widget control application provides a graphical emulation of the second network device and the ordered list is generated by receiving input deleting one or more widgets on the graphical emulation of the second network device.

19. The non-transitory machine-readable storage medium of claim 15, wherein the operations further comprises receiving an identifier of the second network device, the identifier used to associate the second network device with a user account associated with the first network device.

20. The non-transitory machine-readable storage medium of claim 15, wherein the operations further comprises receiving a second configuration file containing a second ordered list of widgets from the first network device for a third network device, and providing the second ordered list to the third network device over a communication network, the third network device having a different platform than the second network device.

21. The method of claim 1, further comprising adding new widgets to and removing obsolete widgets from an original list of widgets, the original list of widgets being provided with the providing of the widget control application upon registration of the first network device with a management server.

22. The method of claim 1, further comprising:
determining that a widget on the list of available widgets is incompatible with the second network device; and
preventing the incompatible widget from being selectable for inclusion in the configuration file.

23. The method of claim 1, wherein the widget control application is a browser-less runtime for rich Internet application that can be deployed on the first network device.

24. The method of claim 1, wherein the determining of the platform comprises accessing an account storing information including platform information on the second network device, the information being received during registration of the second network device.

25. The method of claim 1, wherein the displaying of widgets not compatible with the platform determined for the second network device are displayed as grayed out in the widget control application.

26. The method of claim 1, wherein the displaying of widgets not compatible with the platform determined for the second network device are displayed in a manner that renders them non-selectable by a cursor of the first network device.

27. The method of claim 1, wherein the list of available widgets is based on a location of the second network device.

28. The method of claim 27, wherein the location of the second network device is determined based on user account information stored in a database.

29. The method of claim 1, further comprising:
determining a platform of a third network device, the platform of the third network device being different than the platform of the second network device;
updating the user interface comprising a list of available widgets, the user interface displaying the list of available widgets in a graphical representation of an interface operating on the third network device, the graphical representation of the interface operating on the third network device being different than the graphical representation of the interface operating on the second network device, some of the widgets being compatible with the platform determined for the third network device and some of the widgets not being compatible with the platform determined for the third network device, wherein widgets not compatible with the platform determined for the third network device are displayed as non-selectable in the widget control application;
receiving a configuration file for the third network device created using the user interface on the first network device based on the list of available widgets compatible with the platform determined for the third network device provided to the first network device, the configuration file comprising an ordered list of widgets compatible with the platform determined for the third network device and received from the first network device; and
synchronizing, using at least one processor, the ordered list of widgets with the third network device by providing the ordered list of widgets in the platform determined for the third network device to the third network device over a communication network.
